(19) United States
(12) Patent Application Publication
(10) Pub. No.: US 2010/0190444 A1
(43) Pub. Date: Jul. 29, 2010

(54) RAPID WIRELESS PAIRING METHOD

(76) Inventors: PARVIZ PARHAMI, Long Beach, CA (US); Ken Grindall, Cypress, CA (US)

Correspondence Address: STETINA BRUNDA GARRED & BRUCKER, 75 ENTERPRISE, SUITE 250, ALISO VIEJO, CA, 92656, US

(21) Appl. No.: 12/694,225

(22) Filed: Jan. 26, 2010

Related U.S. Application Data
(60) Provisional application No. 61/147,700, filed on Jan. 27, 2009.

(51) Int. Cl. H04B 7/00; H04Q 5/22

(52) U.S. Cl. 455/41.3; 340/10.1

(57) ABSTRACT

This patent describes a method for rapidly and reliably pairing (connecting) wireless peripherals to target computers. The target computer emits an interrogation signal. After bringing the wireless peripheral in close proximity with the target computer, the peripheral detects the interrogation signal and transmits an identification signal. After receiving the identification signal the target computer establishes a connection between the peripheral and the computer.

### CROSS-REFERENCE TO RELATED APPLICATIONS

This application claims the benefit of U.S. Provisional Application No. 61/147,700, filed on Jan. 27, 2009, the teachings of which are expressly incorporated by reference.

### STATEMENT RE: FEDERALLY SPONSORED RESEARCH/DEVELOPMENT

Not Applicable

### BACKGROUND

This patent describes a method for rapidly and reliably pairing (connecting) wireless peripherals to target computers.

Existing wireless pairing methods generally involve multiple actions by the human operator.

Here are two examples of existing pairing methods:

Headset/phone: When pairing a Bluetooth headset to a cell phone, one has to select a “Bluetooth pairing” menu on the cell phone, then hold a specific button on the headset for a few seconds to put it in a pairing mode, wait until the device is recognized by the cell phone, and then type the code sequence on the cell phone to enable the pairing. Switching to different Bluetooth headset will require repeating the same steps.

Phone/computer: When pairing an iPhone (or iPod Touch) or a similar device to a target computer, given that they are both on the same Wi-Fi communication network, the following steps are executed: The corresponding applications are launched on the two devices, a “pairing command” is manually selected on the target computer application, at which time the computer will display a code, and the code is manually typed into the iPhone application screen. Once the code is accepted by the iPhone application, the two devices become paired on the Wi-Fi network.

In addition to being operator intensive, these pairing methods are prone to interference if multiple nearby computers are paired with their respective peripherals at the same time. These drawbacks make rapid sharing of wireless peripherals among target computers impractical.

The following are sample applications in which such rapid peripheral pairing and exchange can become essential:

Medical Clinic: A number of specialized handheld wireless sensors can be developed for monitoring patient vital signs (stethoscope, thermometer, otoscope, etc.). Each doctor in the medical clinic will be equipped with a handheld computer and access to a number of these sensing peripherals. All computers and sensors will be on the same medical center Wi-Fi wireless network. Each doctor/nurse will need to rapidly pair their hand-held computers to different sensors as they examine a patient without interfering with other examiners doing the same.

Electronic Laboratory/Workshop: A number of specialized wireless sensors can be developed for examining circuits (voltmeter, amp meter, ohmmeter, microscope, etc.). Each technician/engineer will be equipped with a handheld computer and access to a number of these sensing peripherals. All computers and sensors will be on the same local Wi-Fi wireless network. Each technician/engineer will need to rapidly pair their hand-held computer to different sensors as they examine a circuit without interfering with other technicians doing the same.

Ad Hoc Pairings: A number of specialized standalone wireless sensing devices can be developed to rapidly pair on demand with display devices such as a phone, laptop or tablet computer in ad hoc two node networks in a crowded environment where others may be using similar equipment without risk of accidentally pairing with the wrong device, regardless of networking method, be it Bluetooth, Wi-Fi, other point to point wireless or even a data enabled wireless telephone network.

### BRIEF SUMMARY

What is disclosed here is a means for wireless peripherals to be quickly and reliably paired with target computers with minimal operator actions, even in the presence of many other wireless computers/peripherals being similarly paired.

The invented method consists of the following steps for pairing a commercially available computer to an external peripheral:

When the application requiring the peripheral is launched, the target computer continuously emits an interrogation signal 102 localized to the computer/peripheral pair. The interrogation signal need not be in the same wireless band as the target device, it could consist of coded optical flashes of light or acoustic pulses of sound. These codes identify the computer and network information.

When a desired peripheral and a computer are brought into close proximity with each other, the computer's local interrogation signal is detected by the peripheral. In response, the peripheral transmits its unique identification signal 104, localized to the computer/sensor pair, or through the local wireless network, back to the interrogating computer.

The computer identifies the peripheral, a secure wireless connection is established 106, data is transmitted bidirectionally between the computer and the peripheral 108, and the computer displays the appropriate user interface for the paired peripheral. Either of the interrogation signal and identification signal can be optical, acoustic, the same radio frequency (RF) radiation as the wireless network communication signal, a different RF radiation as the wireless network communication signal, an RFID, or bar codes.

The entire method is executed rapidly and reliably with minimal operator intervention. All the operator has to do is to bring the peripheral next to the target computer to establish pairing. Switching to a different peripheral requires the same simple action by the operator. This method allows rapid pairing of wireless peripherals to their respective target computers in the same wireless environment. If a wireless network does not exist, an ad-hoc network is established between the computer and the peripheral.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flowchart depicting an exemplary method of the present invention.

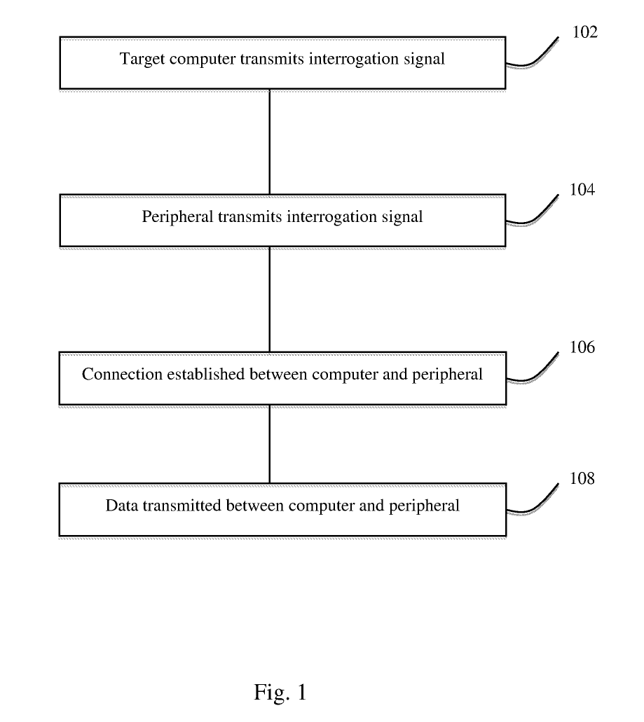

### DETAILED DESCRIPTION

The following disclosure describes one embodiment for rapidly connecting a peripheral designed using this invention with an off-the-shelf hand-held computer (such as an iPhone) when both devices are on the same Wi-Fi communication network (server based or Ad Hoc).

When the peripheral-specific application is executed on the computer, a portion of the computer screen will start flashing a specifically coded pulses of colors with variable pulse widths, and/or intensities 102.

The peripheral will have a built-in light detector capable of detecting the computer generated optical interrogation signal only when placed directly over the flashing screen. One option is for the optical detector window to open only when pressed against the screen, the other option is to have the optical detector window open all the time but require sufficient signal strength to ensure close proximity to the target computer.

Upon detection of the target computer interrogation signal, the peripheral will send an identification signal 104 through the local wireless network, or through a coded sound chirp, to the interrogating computer.

Using information communicated by the computer interrogation signal and the peripheral response signal, a Wi-Fi communication path is established between the computer and the peripheral 106.

If the computer or the peripheral are not on a common wireless network, an adhoc network is established via Wi-Fi or Bluetooth between the computer and the peripheral.

Optionally, the computer emits audible, visible, or tactile feedback to let the user know that the pairing was successful. Data may now be transmitted between the computer and the peripheral 108.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for rapidly and reliably pairing a wireless peripheral to a target computer when they are both on the same wireless network, in which:
a. the target computer emits a unique interrogation signal localized to the computer/peripheral pair;
b. as the desired peripheral is brought into close proximity of the computer, it detects the unique interrogation signal and, in turn, transmits its unique identification signal back to the target computer;
c. the target computer detects the identification signal from the peripheral, identifies the peripheral and establishes a secure connection to it; and
d. data is transmitted between the target computer and the peripheral.

2. The method of claim 1, wherein the interrogation signal transmitted by the target computer and received by the peripheral is optical.

3. The method of claim 1, wherein the interrogation signal transmitted by the target computer and received by the peripheral is acoustic.

4. The method of claim 1, wherein the interrogation signal transmitted by the target computer and received by the peripheral is based on RF radiation other than the wireless network communication signal.

5. The method of claim 1, wherein the interrogation signal transmitted by the target computer and received by the peripheral is by using RFID.

6. The method of claim 1, wherein the interrogation signal transmitted by the target computer and received by the peripheral is based on bar codes.

7. The method of claim 1, wherein the identification signal transmitted by the peripheral and received by the target computer is through the local wireless network.

8. The method of claim 1, wherein the identification signal transmitted by the peripheral and received by the target computer is acoustic.

9. The method of claim 1, wherein the identification signal transmitted by the peripheral and received by the target computer is optical.

10. The method of claim 1, wherein the identification signal transmitted by the peripheral and received by the target computer is based on RF radiation other than the wireless network communication signal.

11. The method of claim 1, wherein the identification signal transmitted by the peripheral and received by the target computer is RFID.

12. The method of claim 1, wherein the identification signal transmitted by the peripheral and received by the target computer is based on bar codes.

13. The method of claim 1, wherein the wireless communication network is a Bluetooth protocol.

14. The method of claim 1, wherein the wireless communication network is a Wi-Fi protocol.

15. The method of claim 1, wherein the wireless communication network is an ad hoc Wi-Fi protocol.

16. The method of claim 1, wherein the wireless communication network is an ad hoc Bluetooth protocol.

17. The method of claim 1, wherein the wireless communication network is based on any future standardized wireless protocol.

18. The method of claim 1, wherein the peripheral initiates the interrogation instead of the target computer.
